(19) United States
(12) Patent Application Publication
(10) Pub. No.: US 2010/0274532 A1
(43) Pub. Date: Oct. 28, 2010

(54) SIGNAL SENSING APPARATUS AND METHOD THEREOF

(75) Inventors: Yi-Shiang Ouyang, Sanchong City (TW); Wen-Ching Lee, Budai Town (TW); Ting-Chen Ke, Taichung City (TW)

Correspondence Address: Wang Law Firm, Inc., 4989 Peachtree Parkway,, Suite 200, Norcross, GA, 30092, US

(73) Assignee: INDUSTRIAL TECHNOLOGY RESEARCH INSTITUTE, Chutung (TW)

(21) Appl. No.: 12/538,132

(22) Filed: Aug. 8, 2009

(30) Foreign Application Priority Data
Apr. 28, 2009 (TW) 098113994

(51) Int. Cl. G06F 15/00

(52) U.S. Cl. 702/191

(57) ABSTRACT

A signal sensing apparatus eliminating noise is provided, having at least a first class signal sensor for receiving at least a first class signal, at least a second class signal sensor for receiving at least a second class signal, a signal receiver for receiving a signal, wherein the signal comprises at least a noise; and a master-slave multiple noise eliminator for performing a multiple adaptive filter algorithm to eliminate noise in the signal by using one of the at least a first class signal or second class signal as a master signal and one of the at least a first class signal or second class signal not used as a master signal as a slave signal.

### CROSS REFERENCE TO RELATED APPLICATIONS

This Non-provisional application claims priority under 35 U.S.C. §119(a) on Patent Application No(s). 98113994, filed in Taiwan, Republic of China on Apr. 28, 2009, the entire contents of which are hereby incorporated by reference.

### TECHNICAL FIELD

The present invention relates to a signal sensing apparatus and method thereof, and in particular relates to a physiological signal sensing apparatus and method for eliminating noise of the signal.

### BACKGROUND

Driven by aging societies, the need for health management has increased. Thus, various physiological monitors have been developed. However, clinical health management may not always be feasible, thus homecare systems have been developed, wherein the physiological monitors are combined with a network.

Since different movements, such as walking, stretching, and walking up or down stairs, result in different types of noises. Thus, adaptive filtering operations based on only one type of noise does not effectively eliminate other types of noises. Moreover, physiological signals are also influenced by the electrode patch pulling on skin due to movement. Despite advances in foresaid homecare systems however, most function of those physiological monitors are applied with a user in static state for capturing better signal. Therefore, foresaid physiological monitors can not be easy to use anytime, anywhere.

### SUMMARY

According to one embodiment, a signal sensing apparatus is provided. The signal sensing apparatus comprises a first class signal sensor for receiving a first class signal; a second class signal sensor for receiving a second class signal; a signal receiver for receiving a signal, wherein the signal comprises at least a type of noise; and a noise eliminator for performing a multiple adaptive filter algorithm to eliminate noise in the signal by using one of the first class signal or second class signal as a master signal and another one of the first class signal or second class signal as a slave signal.

According to another one embodiment, a signal sensing method is provided. The signal sensing method comprises: receiving a first class signal; receiving a second class signal; receiving a signal, wherein the signal comprises a noise; and performing a multiple adaptive filter algorithm to eliminate noise in the signal by using one of the first class signal or second class signal as a master signal and another one of the first class signal or second class signal not used as a master signal as a slave signal.

### BRIEF DESCRIPTION OF DRAWINGS

The present invention can be more fully understood by reading the subsequent detailed description and examples with references made to the accompanying drawings, wherein:

FIG. 1 is a schematic diagram of a signal sensing apparatus eliminating noise according to an embodiment;

FIG. 2A is a flow chart of the signal sensing method according to the embodiment in FIG. 1;

FIG. 2B is a flow chart of the step S240 of an embodiment.

### DETAILED DESCRIPTION

A detailed description is given in the following embodiments with reference to the accompanying drawings.

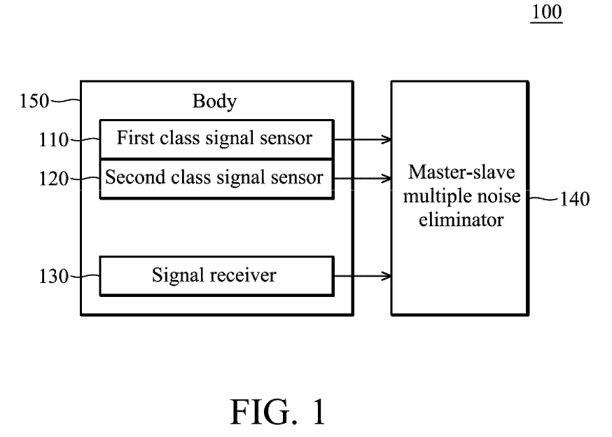

FIG. 1 is a schematic diagram of a signal sensing apparatus according to one embodiment. The signal sensing apparatus 100 comprises a first class signal sensor 110, a second class signal sensor 120, a signal receiver 130 and a master-slave multiple noise eliminator 140. The first class signal sensor 210 receives a first class signal, the second class signal sensor 120 receives a second class signal, and the signal receiver 130 receives a signal. For convenience, in this embodiment the first class signal is an inertia signal having at least one dimension, the second class signal is a deformation signal having at least one dimension, the signal received by the signal receiver may be a physiological signal, e.g., an electrocardiogram signal, which may be measured by the signal receiver attached to a subject, and the signal receiver may be a electrode patch, but the present invention is not limited thereto.

When a subject is measured by the signal sensing apparatus 100 according to the embodiment, and performs various activities such as running, walking, or walking upstairs or downstairs, inertia signals are generated to influence electrocardiogram signals. The first class sensor 110 measures the inertia signal, and may be implemented as an accelerometer or a gyroscope. Meanwhile, when a subject performs activities such as breathing heavily wherein the chest expands or stretching, the electrode pulling on skin influences electrocardiogram signals. The signals influenced by the electrode pulling on skin are called deformation signals. Thus, the second class sensor 120 measures the deformation signals, and may be implemented as a strain gauge, a tension sensor, or a bending sensor. Experiment results show that these two class signals caused by different movements may result in different kinds of interferences or noises in the electrocardiogram signals.

In the embodiment, the master-slave multiple noise eliminator 140 of the signal sensing apparatus 100 processes the electrocardiogram signals mentioned above and eliminates interferences or noises. The master-slave multiple noise eliminator 140 performs a multiple adaptive filtering process to eliminate noise in the signal by using one of the inertia signal or deformation signal as a master signal and another one of the inertia signal or deformation signal not used as a master signal as a slave signal. Specifically, the master-slave multiple noise eliminator 140 respectively analyzes the correlation between the inertia signal and the physiological signal and the correlation between the deformation signal and the electrocardiogram signal. When the inertia signal has a higher correlation with the electrocardiogram signal, the master-slave multiple noise eliminator 140 may decide that noises in the electrocardiogram signal are mainly caused from the inertia motion, and may use the inertia signal as the master signal and use the deformation signal as the slave signal to perform the multiple adaptive filtering process to eliminate noises in the signal. However, when the deformation signal has the higher correlation with the electrocardiogram signal, the master-slave multiple noise eliminator 140 may decide that noises in the electrocardiogram signal are mainly caused from the electrode pulling on skin, and may use the deformation signal as the master signal and use the inertia signal as the slave signal to perform the multiple adaptive filtering process to eliminate noises in the signal. Although there are only two classes of signals described in this embodiment, the present invention is not limited thereto. In addition, the adaptive filtering process may include Least Mean Square algorithm, Recursive Least Square algorithm, or Lattice algorithm.

In one embodiment, the electrode used to measure the electrocardiogram signal may be separated from the other sensors of the signal sensing apparatus 100. In addition to the electrode attached to a subject, the signal sensing apparatus 100 further comprises a body 150, wherein the body 150 comprises the first class signal sensor 110 and the second class signal sensor 120. Since the second class signal sensor 120 used to measure the skin deformation caused by the electrode pulling on skin is not on the pad of the electrode, it is unnecessary for the second class signal sensor 120 to be replaced. In other words, the sensor 120 of the present embodiment is reusable.

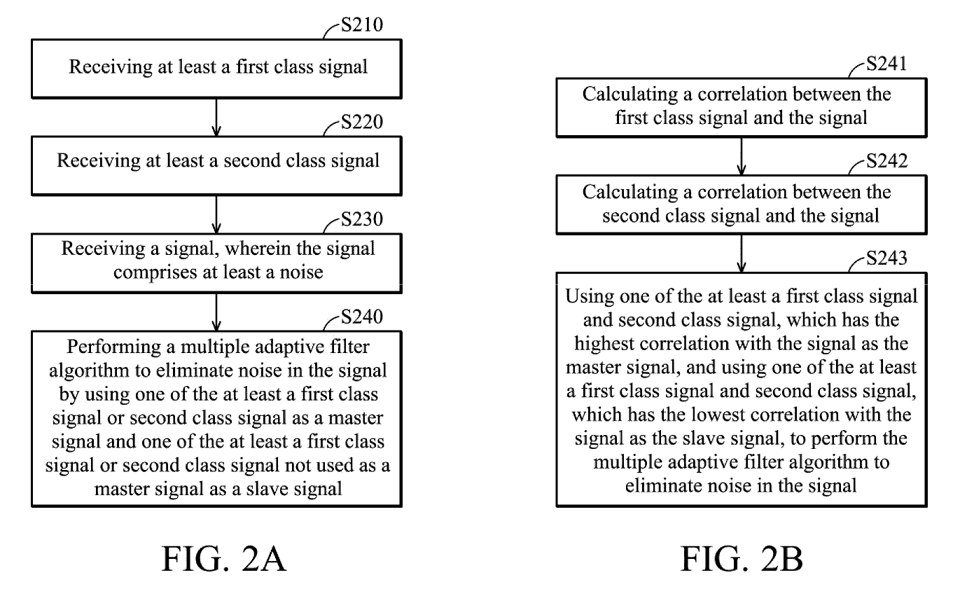

FIG. 2A is a flow chart of the signal sensing method according to another embodiment. The method comprises: the step S210 of receiving a first class signal; the step S220 of receiving a second class signal; the step S230 of receiving a signal; and the step S240 of performing a multiple adaptive filter algorithm to eliminate at least one class of noise in the signal by using one of the first class signal or second class signal as a master signal and one of the first class signal or second class signal not used as a master signal as a slave signal. FIG. 2B is a flow chart of the step S240 of another embodiment. The step S240 further comprises: the step S241 of calculating a correlation between the first class signal and the signal; the step S2342 of calculating a correlation between the second class signal and the signal; and the step S243 of using one of the at least a first class signal and second class signal, which has the highest correlation with the signal as the master signal, and using one of the at least a first class signal and second class signal, which has the lowest correlation with the signal as the slave signal, to perform the multiple adaptive filtering process to eliminate the noise in the signal. In addition, the multiple adaptive filtering process may be Least Mean Square algorithm, Recursive Least Square algorithm or Lattice algorithm.

While the invention has been described by way of example and in terms of the embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A signal sensing apparatus, comprising:
a first class signal sensor for receiving a first class signal;
a second class signal sensor for receiving a second class signal;
a main signal receiver for receiving a signal; and
a master-slave multiple noise eliminator for performing a multiple adaptive filter algorithm to eliminate a noise in the signal by using one of the first class signal or second class signal as a master signal and another one of the first class signal or second class signal as a slave signal.

2. The signal sensing apparatus as claimed in claim 1, wherein the first class signal sensor is an inertia sensor.

3. The signal sensing apparatus as claimed in claim 1, wherein the second class signal sensor is a deformation sensor.

4. The signal sensing apparatus eliminating noise as claimed in claim 1, wherein the signal is a physiological signal.

5. The signal sensing apparatus as claimed in claim 4, wherein the physiological signal is an electrocardiogram signal.

6. The signal sensing apparatus as claimed in claim 1, wherein the master-slave multiple noise eliminator:
calculates correlation between the first class signal and the signal;
calculates correlation between the second class signal and the signal; and
uses the first class signal or second class signal which has the highest correlation with the signal as the master signal, and uses the first class signal or second class signal which has the lowest correlation with the signal as the slave signal, to perform the multiple adaptive filter algorithm to eliminate noise in the signal.

7. The signal sensing apparatus as claimed in claim 1 further comprising:
a body for bearing the first class signal sensor and the second class signal sensor.

8. The signal sensing apparatus as claimed in claim 2, wherein the first class sensor is an accelerometer.

9. The signal sensing apparatus as claimed in claim 2, wherein the first class sensor is a gyroscope.

10. The signal sensing apparatus as claimed in claim 3, wherein the second class sensor is a strain gauge.

11. The signal sensing apparatus as claimed in claim 3, wherein the second class sensor is a tension sensor.

12. The signal sensing apparatus as claimed in claim 3, wherein the second class sensor is a bending sensor.

13. The signal sensing apparatus as claimed in claim 4, wherein the signal receiver comprises an electrode.

14. A signal sensing method, comprising:
receiving a first class signal;
receiving a second class signal;
receiving a signal, wherein the signal comprises at least one class of noise; and
performing a multiple adaptive filtering process to eliminate the noise in the signal by using one of the first class signal or second class signal as a master signal and another one of the first class signal or second class signal as a slave signal.

15. The signal sensing method as claimed in claim 14, wherein the step for performing a Multiple adaptive filtering process to eliminate the noise in the signal by using one of the first class signal or second class signal as a master signal and another one of the first class signal or second class signal as a slave signal, comprising:
calculating a correlation between the first class signal and the signal;
calculating a correlation between the second class signal and the signal; and
using one of the first class signal and second class signal, which has the highest correlation with the signal as the master signal, and using another one of the first class signal and second class signal, which has the lowest correlation with the signal as the slave signal, to perform the multiple adaptive filter algorithm to eliminate noise in the signal.

16. The signal sensing method as claimed in claim 14, wherein the multiple adaptive filtering process comprises a Least Mean Square algorithm.

17. The signal sensing method as claimed in claim 14, wherein the multiple adaptive filtering process comprises a Recursive Least Square algorithm.

18. The signal sensing method as claimed in claim 14, wherein the multiple adaptive filtering process comprises the Lattice algorithm.
